(19) United States
(12) Patent Application Publication
(10) Pub. No.: US 2021/0257700 A1
(43) Pub. Date: Aug. 19, 2021

(54) BATTERY DEVICE WITH PRESSURE RELIEF VALVE

(71) Applicants: Cheng Uei Precision Industry Co., Ltd., New Taipei City (TW); Foxlink Automotive Technology (Kunshan) Co., Ltd., Kun Shan City (CN); Foxlink Automotive Technology Co., Ltd., New Taipei City (TW)

(72) Inventors: MIN YU WU, New Taipei City (TW); TA CHANG YANG, New Taipei City (TW)

(21) Appl. No.: 17/123,043

(22) Filed: Dec. 15, 2020

(30) Foreign Application Priority Data
Feb. 17, 2020 (CN) 202020176478.0

(51) Int. Cl. H01M 50/342; H01M 50/204; H01M 50/244; H01M 50/271; H01M 50/512

(52) U.S. Cl. CPC H01M 50/3425; H01M 50/204; H01M 2200/20; H01M 50/271; H01M 50/512; H01M 50/244

(57) ABSTRACT

A battery device with pressure relief valve includes a battery module, a holder, a shell surrounding the battery module, a first cover mounted to one end of the shell, a pressure relief valve, and a second cover mounted to the other end of the shell. The battery module includes a plurality of batteries interconnected in series or in parallel. The plurality of the batteries are fastened to the holder. The first cover has a fastening hole communicated with an inside of the shell and an outside. The pressure relief valve fastened in the fastening hole, has a base area and a thin area. The base area surrounds the thin area. Several portions of a middle of a bottom surface of the thin area are recessed inward to form a plurality of indentations intersected to form a dehiscent point located at a junction among the plurality of the indentations.

### CROSS-REFERENCE TO RELATED APPLICATION

The present application is based on, and claims priority from, China Patent Application No. 202020176478.0, filed Feb. 17, 2020, the disclosure of which is hereby incorporated by reference herein in its entirety.

### BACKGROUND OF THE INVENTION

### 1. Field of the Invention

The present invention generally relates to a battery device with pressure relief valve, and more particularly to a battery device with pressure relief valve capable of effectively expelling an air pressure formed and accumulated in the battery device with pressure relief valve.

### 2. The Related Art

Nowadays, a conventional battery device with pressure relief valve is used widely. The conventional battery device with pressure relief valve is surrounded by a shell. However, in a process of using the conventional battery device with pressure relief valve, the conventional battery device with pressure relief valve generates gaseous substances, and the gaseous substances generated by the conventional battery device with pressure relief valve will be accumulated in the shell that makes an air pressure inside the shell rises, consequently, the conventional battery device with pressure relief valve is easily affected, and the conventional battery device with pressure relief valve is even caused to be exploded.

Therefore, it is essential to provide an innovative battery device with pressure relief valve which is capable of effectively expelling an air pressure formed and accumulated in the innovative battery device with pressure relief valve.

### SUMMARY OF THE INVENTION

An object of the present invention is to provide a battery device with pressure relief valve capable of effectively expelling an air pressure formed and accumulated in the battery device with pressure relief valve. The battery device with pressure relief valve includes a battery module, a holder, a shell surrounding the battery module, a first cover, a pressure relief valve, and a second cover mounted to the other end of the shell. The battery module includes a plurality of battery groups which include a plurality of batteries interconnected in parallel. The plurality of the batteries are fastened to the holder. The first cover is mounted to one end of the shell. The first cover has a fastening hole penetrating through the first cover. The fastening hole is communicated with an inside of the shell and an outside. The pressure relief valve is fastened in the fastening hole. Several portions of a middle of a bottom surface of the pressure relief valve are recessed inward to form a plurality of indentations. The plurality of the indentations are intersected with one another to form a dehiscent point located at a junction among the plurality of the indentations.

Another object of the present invention is to provide a battery device with pressure relief valve. The battery device with pressure relief valve includes a battery module, a holder, a shell surrounding the battery module, a first cover, a pressure relief valve and a second cover. The battery module includes a plurality of batteries interconnected in series. The plurality of the batteries are fastened to the holder. The first cover is mounted to one end of the shell. The first cover has a fastening hole penetrating through the first cover. The fastening hole is communicated with an inside of the shell and an outside. The pressure relief valve is fastened in the fastening hole. Several portions of a middle of a bottom surface of the pressure relief valve are recessed inward to form a plurality of indentations. The plurality of the indentations are intersected with one another to form a dehiscent point located at a junction among the plurality of the indentations. The second cover is mounted to the other end of the shell.

Another object of the present invention is to provide a battery device with pressure relief valve. The battery device with pressure relief valve includes a battery module, a holder, a shell surrounding the battery module, a first cover, a pressure relief valve and a second cover. The battery module includes a plurality of batteries interconnected in series or in parallel. The plurality of the batteries are fastened to the holder. The first cover is mounted to one end of the shell. The first cover has a fastening hole penetrating through the first cover. The fastening hole is communicated with an inside of the shell and an outside. The pressure relief valve is fastened in the fastening hole by an injection molding technology. The pressure relief valve has a base area and a thin area. The base area surrounds the thin area. Several portions of a middle of a bottom surface of the thin area are recessed inward to form a plurality of indentations. The thin area is molded to the base area. The plurality of the indentations are intersected with one another to form a dehiscent point located at a junction among the plurality of the indentations. The second cover is mounted to the other end of the shell.

As described above, the pressure relief valve is fastened to the first cover, an air pressure generated inside the battery module is able to be released from the pressure relief valve to prevent gaseous substances from being accumulated in the battery module, and the battery device with pressure relief valve is capable of effectively expelling the air pressure formed and accumulated in the battery device with pressure relief valve, so that a damage of the plurality of the batteries of the battery module is prevented.

### BRIEF DESCRIPTION OF THE DRAWINGS

The present invention will be apparent to those skilled in the art by reading the following description, with reference to the attached drawings, in which:

FIG. 1 is a perspective view of a battery device with pressure relief valve in accordance with a preferred embodiment of the present invention;

FIG. 2 is an exploded view of the battery device with pressure relief valve of FIG. 1;

FIG. 3 is a perspective view of a pressure relief valve of the battery device with pressure relief valve in accordance with the present invention;

FIG. 4 is a sectional view of the battery device with pressure relief valve along a line IV-IV of FIG. 1; and

FIG. 5 is an enlarged view of an encircled portion V of the battery device with pressure relief valve of FIG. 4.

### DETAILED DESCRIPTION OF THE PREFERRED EMBODIMENT

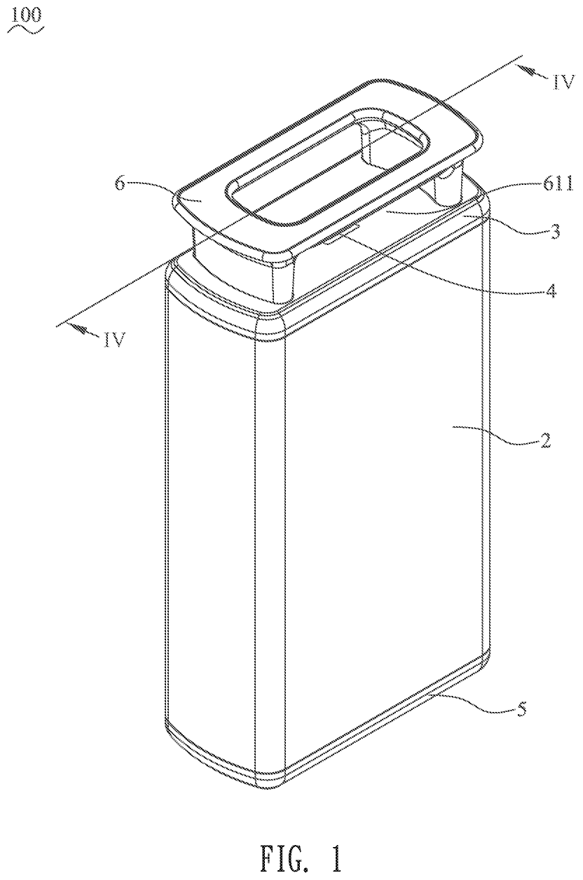

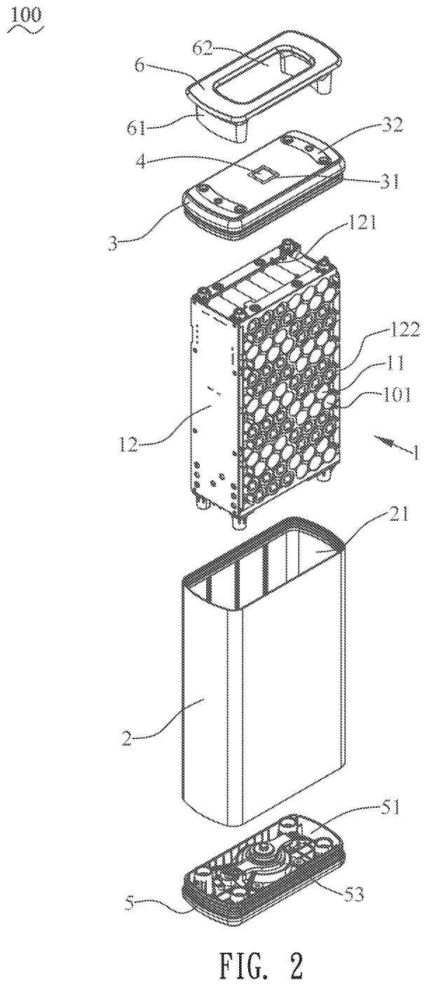

With reference to FIG. 1 and FIG. 2, a battery device with pressure relief valve 100 in accordance with a preferred embodiment of the present invention is shown. The battery device with pressure relief valve 100 includes a battery module 1, a shell 2, a first cover 3, a pressure relief valve 4 and a second cover 5.

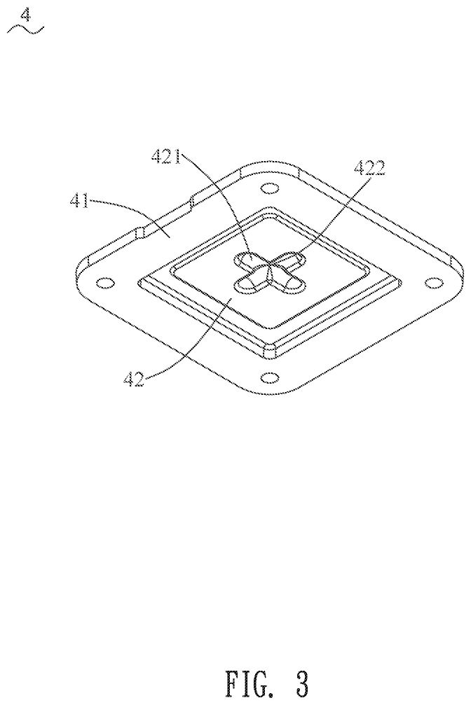

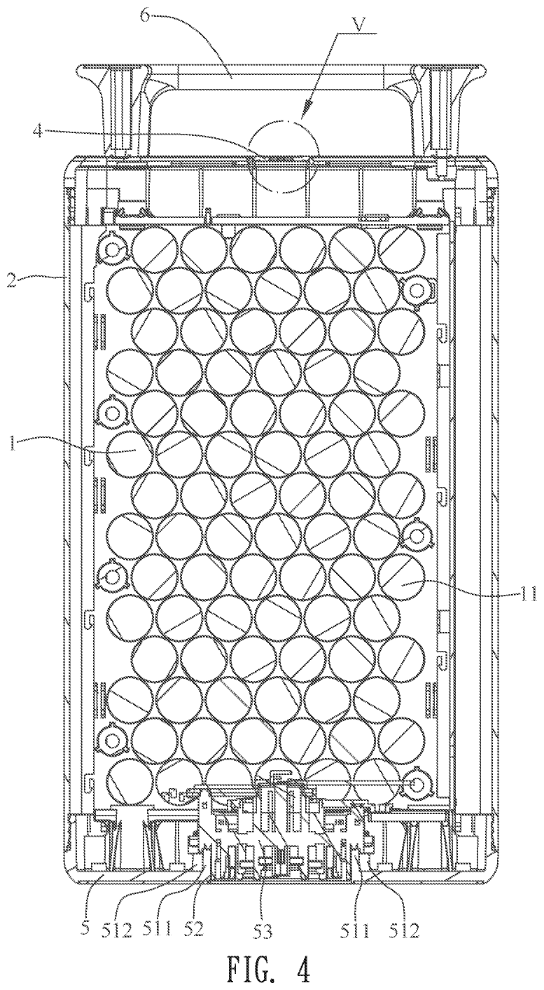

With reference to FIG. 1 to FIG. 4, the battery module 1 includes a plurality of battery groups 101 which include a plurality of batteries 11, and a holder 12. The battery module 1 has the plurality of the batteries 11. The holder 12 is hollow. An inside of the holder 12 defines a holding space 121. A front and a rear of the holder 12 defines a plurality of circular through-holes 122 communicated with the holding space 121. The plurality of the batteries 11 are fastened to the holder 12. In the preferred embodiment, the battery module 1 includes fourteen battery groups 101. Each battery group 101 includes six batteries 11. Cathodes and anodes of the plurality of the batteries 11 of the battery groups 101 are exposed outside from the through-holes 122 of the front and the rear of the holder 12.

The cathodes and the anodes of the plurality of the batteries 11 of the battery groups 101 exposed out of the through-holes 122 of the front of the holder 12 are alternately arranged. The cathodes and the anodes of the plurality of the batteries 11 of the battery groups 101 exposed out of the through-holes 122 of the rear of the holder 12 are alternately arranged. The cathodes and the anodes of the plurality of the batteries 11 of each two adjacent battery groups 101 exposed out of the through-holes 122 of the front of the holder 12 and arranged along a transverse direction are different, and the cathodes and the anodes of the plurality of the batteries 11 of each two adjacent battery groups 101 exposed out of the through-holes 122 of the front of the holder 12 and arranged along an up-down direction are different. The cathodes and the anodes of the plurality of the batteries 11 of each two adjacent battery groups 101 exposed out of the through-holes 122 of the rear of the holder 12 and arranged along the transverse direction are different, and the cathodes and the anodes of the plurality of the batteries 11 of each two adjacent battery groups 101 exposed out of the through-holes 122 of the rear of the holder 12 and arranged along the up-down direction are different.

The shell 2 is hollow. A middle of the shell 2 has a receiving space 21 penetrating through middles of a top surface and a bottom surface of the shell 2. The shell 2 surrounds the battery module 1. The battery module 1 is received in the receiving space 21. The plurality of the batteries 11 are interconnected in series, or the plurality of the batteries 11 are interconnected in parallel. A top end of the battery module 1 is exposed from a top end of the shell 2, and a bottom end of the battery module 1 is exposed from a bottom end of the shell 2.

The first cover 3 is mounted to one end of the shell 2. The second cover 5 is mounted to the other end of the shell 2. The first cover 3 has a fastening hole 31 vertically penetrating through the first cover 3. The fastening hole 31 is communicated with an inside of the shell 2 and an outside. Specifically, the first cover 3 is mounted on the top end of the shell 2. A middle of the first cover 3 has the fastening hole 31 vertically penetrating through a top and a bottom of the first cover 3. The second cover 5 is mounted to the bottom end of the shell 2.

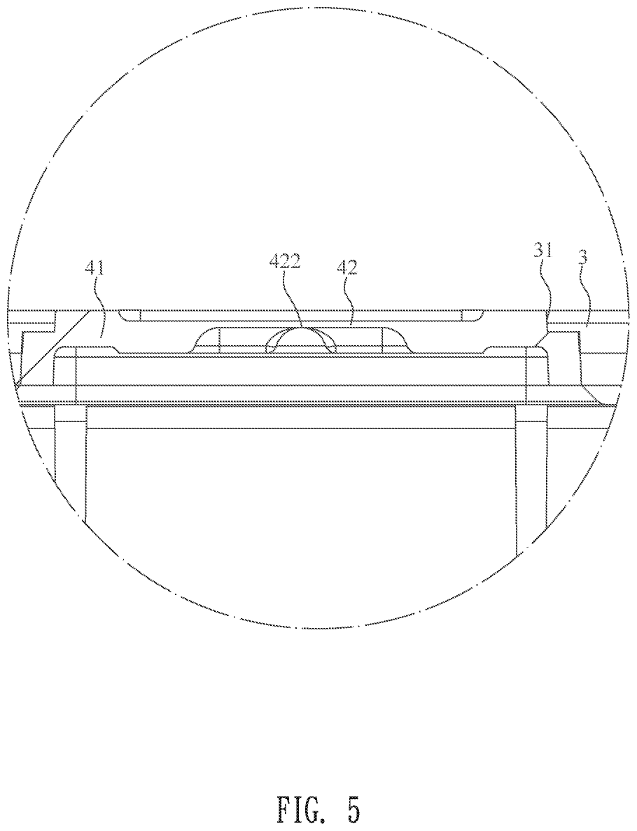

Referring to FIG. 2 to FIG. 5, the pressure relief valve 4 is fastened in the fastening hole 31 by an injection molding technology. In the preferred embodiment, the pressure relief valve 4 is shown as a square shape. The pressure relief valve 4 has a base area 41 and a thin area 42. The base area 41 is a plastic body. The thin area 42 is a small slice. The thin area 42 is located at a middle of the pressure relief valve 4. In the preferred embodiment, the base area 41 is shown as a square frame shape. The base area 41 surrounds the thin area 42. The base area 41 is connected with a periphery of the thin area 42. The thin area 42 is thinner than the base area 41 along the up-down direction. A thickness of the thin area 42 is smaller than a thickness of the base area 41.

Several portions of a middle of a bottom surface of the pressure relief valve 4 are recessed inward to form a plurality of indentations 421. The plurality of the indentations 421 are intersected with one another to form a dehiscent point 422 located at a junction among the plurality of the indentations 421. Several portions of a middle of a bottom surface of the thin area 42 are recessed inward to form the plurality of the indentations 421. In the preferred embodiment, the plurality of the indentations 421 are shown as elongated shapes. The plurality of the indentations 421 located to the thin area 42 are intersected to form the dehiscent point 422 located at the junction among the plurality of the indentations 421 and located at the middle of the bottom surface of the thin area 42. In the preferred embodiment, the plurality of the indentations 421 are shown as a cross shape and the dehiscent point 422 is located at the middle of the bottom surface of the thin area 42. The plurality of the indentations 421 are extended outward from the dehiscent point 422 at intervals, and an angle between each two adjacent indentations 421 is equal to an angle between any two adjacent indentations 421. In the preferred embodiment, the plurality of the indentations 421 include four indentations 421. In practice, a quantity of the plurality of the indentations 421 is without being limited to the quantity of the plurality of the indentations 421 in accordance with the preferred embodiment. If only the plurality of the indentations 421 are able to be intersected at the dehiscent point 422, the quantity of the plurality of the indentations 421 is permissible.

The pressure relief valve 4 is a design of the thin area 42 being embedded and molded to the base area 41 which is the plastic body after the thin area 42 which is the small slice is individually molded by the injection molding technology. Thicknesses of different plastics are different, the thin area 42 is individually molded by the injection molding technology, and then the thin area 42 is molded to the base area 41 by virtue of an embedding method, so that an injection molding difficulty situation is improved at the time of the thin area 42 and the base area 41 being made of the different plastics with the different thicknesses.

Referring to FIG. 1 to FIG. 5, when the battery device with pressure relief valve 100 is used by a user, the battery module 1 includes the plurality of the batteries 11 interconnected in series or in parallel, and an inside of the battery module 1 has an air pressure, the plurality of the thinner indentations 421 of the thin area 42 will generate a stress concentration phenomenon, and the above-mentioned stress will be aggregated in the dehiscent point 422 along the plurality of the indentations 421 of the thin area 42 to make the dehiscent point 422 be under a largest stress, so a most vulnerable position of the thin area 42 will be located at the dehiscent point 422. When the air pressure of the inside of the battery module 1 exceeds a threshold value, the dehiscent point 422 of the pressure relief valve 4 generates an crevice, and the plurality of the indentations 421 are split. When the air pressure of the inside of the battery module 1 exceeds the threshold value, the dehiscent point 422 of the thin area 42 generates the crevice, and the thin area 42 is split outward along the plurality of the indentations 421 to release gaseous substances generated by the plurality of the batteries 11. In the preferred embodiment, the plurality of the indentations 421 are split and are shown as a radial shape. Because the plurality of the indentations 421 are split and are shown as the radial shape, the user will be unable to be hurt on account of objects of the thin area 42 being separated.

In addition, because the dehiscent point 422 and the plurality of the indentations 421 apply a way of being gradually split from one point to the plurality of the radial indentations 421, the pressure relief valve 4 releases the gaseous substances from the crevice to the plurality of the split indentations 421 to gradually release high-pressure gaseous substances, so that the air pressure of the inside of the battery module 1 is gradually lowered, and then when the plurality of the indentations 421 continues being split outward, and the air pressure of the inside of the battery module 1 has been partially released, so the air pressure of the inside of the battery module 1 is lower to make a speed of releasing the gaseous substances to get a retard, and a large amount of the high-pressure gaseous substances are prevented from being released to send out a crackle.

Referring to FIG. 1 to FIG. 5 again, a top of the first cover 3 is connected with a handle 6. Two opposite sides of a bottom surface of the handle 6 extend downward to form two first connecting portions 61. The two first connecting portions 61 are spaced from each other to form an interval 611 between the two first connecting portions 61. A middle of a top of the handle 6 defines an opening 62. In the preferred embodiment, the opening 62 is shown as a rectangular shape. The opening 62 is located above the fastening hole 31 and the pressure relief valve 4. Two opposite sides of a top of an outer surface of the first cover 3 define two second connecting portions 32 corresponding to the two first connecting portions 61. The fastening hole 31 is located between the two first connecting portions 61, so the pressure relief valve 4 fastened in the fastening hole 31 is located between the two first connecting portions 61. The fastening hole 31 is arranged at a middle of a lower portion of the interval 611, so the pressure relief valve 4 fastened in the fastening hole 31 is arranged at the middle of the lower portion of the interval 611.

The second cover 5 is hollow. An inside of the second cover 5 has an accommodating space 51 penetrating through a top of the second cover 5. A middle of a bottom of the second cover 5 defines a locating hole 52 communicated with the accommodating space 51. In the preferred embodiment, a middle of a bottom wall of the accommodating space 51 protrudes upward to form a ring-shaped supporting bracket 511 projecting into the accommodating space 51. The supporting bracket 511 surrounds a top of the locating hole 51. In the preferred embodiment, an outer periphery of the supporting bracket 511 is equipped with a plurality of ring-shaped propping elements 512. The accommodating space 51 is equipped with a power connector 53. The power connector 53 is supported by the supporting bracket 511 and the plurality of the propping elements 512. The power connector 53 is exposed out of the locating hole 52. The power connector 53 is able to be electrically connected with an external equipment to output an electric power of the battery module 1 outward.

As described above, the pressure relief valve 4 is fastened to the first cover 3, the air pressure generated inside the battery module 1 is able to be released from the pressure relief valve 4 to prevent the gaseous substances from being accumulated in the battery module 1, and the battery device with pressure relief valve 100 is capable of effectively expelling the air pressure formed and accumulated in the battery device with pressure relief valve 100, so that a damage of the plurality of the batteries 11 of the battery module 1 is prevented.

What is claimed is:

1. A battery device with pressure relief valve, comprising:
a battery module including a plurality of battery groups which include a plurality of batteries interconnected in parallel;
a holder, the plurality of the batteries being fastened to the holder;
a shell surrounding the battery module;
a first cover mounted to one end of the shell, the first cover having a fastening hole penetrating through the first cover, the fastening hole being communicated with an inside of the shell and an outside;
a pressure relief valve fastened in the fastening hole, several portions of a middle of a bottom surface of the pressure relief valve being recessed inward to form a plurality of indentations, the plurality of the indentations being intersected with one another to form a dehiscent point located at a junction among the plurality of the indentations; and
a second cover mounted to the other end of the shell.

2. The battery device with pressure relief valve as claimed in claim 1, wherein the plurality of the indentations are extended outward from the dehiscent point at intervals, and an angle between each two adjacent indentations is equal to an angle between any two adjacent indentations.

3. The battery device with pressure relief valve as claimed in claim 1, wherein the pressure relief valve has a base area and a thin area, the base area surrounds the thin area, several portions of a middle of a bottom surface of the thin area are recessed inward to form the plurality of the indentations, the plurality of the indentations located to the thin area are intersected to form the dehiscent point located at the junction among the plurality of the indentations and located at the middle of the bottom surface of the thin area.

4. The battery device with pressure relief valve as claimed in claim 3, wherein the thin area is thinner than the base area.

5. The battery device with pressure relief valve as claimed in claim 3, wherein when an air pressure of an inside of the battery module exceeds a threshold value, the dehiscent point of the thin area generates an crevice, and the thin area is split outward along the plurality of the indentations to release gaseous substances generated by the plurality of the batteries.

6. The battery device with pressure relief valve as claimed in claim 1, wherein the plurality of the indentations are shown as a cross shape.

7. The battery device with pressure relief valve as claimed in claim 1, wherein the plurality of the indentations are shown as elongated shapes.

8. The battery device with pressure relief valve as claimed in claim 1, wherein the first cover is mounted on a top end of the shell, a middle of the first cover has the fastening hole vertically penetrating through a top and a bottom of the first cover, the second cover is mounted to a bottom end of the shell.

9. The battery device with pressure relief valve as claimed in claim 8, wherein the second cover is hollow, an inside of the second cover has an accommodating space penetrating through a top of the second cover, a middle of a bottom of the second cover defines a locating hole communicated with the accommodating space, the accommodating space is equipped with a power connector, the power connector is exposed out of the locating hole.

10. The battery device with pressure relief valve as claimed in claim 8, wherein a middle of a bottom wall of the accommodating space protrudes upward to form a ring-shaped supporting bracket projecting into the accommodating space, the supporting bracket surrounds a top of the locating hole, an outer periphery of the supporting bracket is equipped with a plurality of ring-shaped propping elements, the power connector is supported by the supporting bracket and the plurality of the propping elements.

11. The battery device with pressure relief valve as claimed in claim 1, wherein a top of the first cover is connected with a handle, two opposite sides of a bottom surface of the handle extend downward to form two first connecting portions, two opposite sides of a top of an outer surface of the first cover define two second connecting portions corresponding to the two first connecting portions, the fastening hole is located between the two first connecting portions, so the pressure relief valve fastened in the fastening hole is located between the two first connecting portions.

12. The battery device with pressure relief valve as claimed in claim 11, wherein the two first connecting portions are spaced from each other to form an interval between the two first connecting portions, a middle of a top of the handle defines an opening, the opening is located above the fastening hole and the pressure relief valve.

13. The battery device with pressure relief valve as claimed in claim 12, wherein the fastening hole is arranged at a middle of a lower portion of the interval, so the pressure relief valve fastened in the fastening hole is arranged at the middle of the lower portion of the interval.

14. A battery device with pressure relief valve, comprising:
a battery module including a plurality of batteries interconnected in series;
a holder, the plurality of the batteries being fastened to the holder;
a shell surrounding the battery module;
a first cover mounted to one end of the shell, the first cover having a fastening hole penetrating through the first cover, the fastening hole being communicated with an inside of the shell and an outside;
a pressure relief valve fastened in the fastening hole, several portions of a middle of a bottom surface of the pressure relief valve being recessed inward to form a plurality of indentations, the plurality of the indentations being intersected with one another to form a dehiscent point located at a junction among the plurality of the indentations; and
a second cover mounted to the other end of the shell.

15. The battery device with pressure relief valve as claimed in claim 14, wherein when an air pressure of an inside of the battery module exceeds a threshold value, the dehiscent point generates an crevice, and the plurality of the indentations are split.

16. A battery device with pressure relief valve, comprising:
a battery module having a plurality of batteries interconnected in series or in parallel;
a holder, the plurality of the batteries being fastened to the holder;
a shell surrounding the battery module;
a first cover mounted to one end of the shell, the first cover having a fastening hole penetrating through the first cover, the fastening hole being communicated with an inside of the shell and an outside;
a pressure relief valve fastened in the fastening hole by an injection molding technology, the pressure relief valve having a base area and a thin area, the base area surrounding the thin area, several portions of a middle of a bottom surface of the thin area being recessed inward to form a plurality of indentations, the thin area being molded to the base area, the plurality of the indentations being intersected with one another to form a dehiscent point located at a junction among the plurality of the indentations; and
a second cover mounted to the other end of the shell.

17. The battery device with pressure relief valve as claimed in claim 16, wherein when an air pressure of an inside of the battery module exceeds a threshold value, the dehiscent point generates an crevice, and the plurality of the indentations are split.

18. The battery device with pressure relief valve as claimed in claim 16, wherein the pressure relief valve is a design of the thin area being embedded and molded to the base area which is a plastic body after the thin area which is a small slice is individually molded by the injection molding technology.
